(19) United States
(12) Patent Application Publication
(10) Pub. No.: US 2024/0248451 A1
(43) Pub. Date: Jul. 25, 2024

(54) OPERATION CONTROL DEVICE AND METHOD

(71) Applicant: Toshiba Tec Kabushiki Kaisha, Tokyo (JP)

(72) Inventor: Satoshi KATSUMATA, Numazu Shizuoka (JP)

(73) Assignee: Toshiba Tec Kabushiki Kaisha, Tokyo (JP)

(21) Appl. No.: 18/538,854

(22) Filed: Dec. 13, 2023

(30) Foreign Application Priority Data
Jan. 19, 2023 (JP) 2023-006552

(51) Int. Cl. G05B 19/05

(52) U.S. Cl. CPC G05B 19/05; G05B 2219/163

(57) ABSTRACT

An operation control device includes a controller. The controller is configured to receive a component of operation information from each of several user terminals. Each component of operation information indicates a requested command for a target device. The controller is configured to generate a command for the target device based on the components of operation information. The controller is configured to control the target device in accordance with the generated command.

### CROSS-REFERENCE TO RELATED APPLICATION

This application is based upon and claims the benefit of priority from Japanese Patent Application No. 2023-006552, filed on Jan. 19, 2023, the entire contents of which are incorporated herein by reference.

### FIELD

Embodiments described herein relate generally to a technology for operating a common device by a plurality of users.

### BACKGROUND

In the related art, there are technologies that allow target devices such as home appliances to be remotely operated from user terminals such as smartphones and tablets. These technologies are implemented, for example, in such a manner that information is transmitted to a server based on an operation performed on the user terminal, and the server controls the operation of the target device.

If the target device is used by a plurality of people, different control instructions may be given to one target device from a plurality of the user terminals. In such a case, there is a possibility that the target device cannot be controlled appropriately.

### DESCRIPTION OF THE DRAWINGS

FIG. 1 is a diagram showing a configuration example of a control system;

FIG. 2 is a diagram showing a specific example of a functional configuration of a user terminal;

FIG. 3 is a diagram showing a specific example of a screen serving as a user interface provided by an operation control unit;

FIG. 4 is a schematic block diagram showing an example of a functional configuration of an operation control device;

FIG. 5 is a sequence chart showing one specific example of an operation of the control system;

FIG. 6 is a sequence chart showing one specific example of the operation of the control system; and

FIG. 7 is a diagram showing a specific example of the control system.

### DETAILED DESCRIPTION

There is provided an operation control device and an operation control method that make it possible to more appropriately control a target device used by a plurality of people.

In general, according to one embodiment, an operation control device includes a controller. The controller receives a piece of operation information from each of several user terminals. Each piece of operation information indicates a requested command for a target device. The controller generates a command for the target device based on the pieces of operation information. The controller controls the target device in accordance with the generated command.

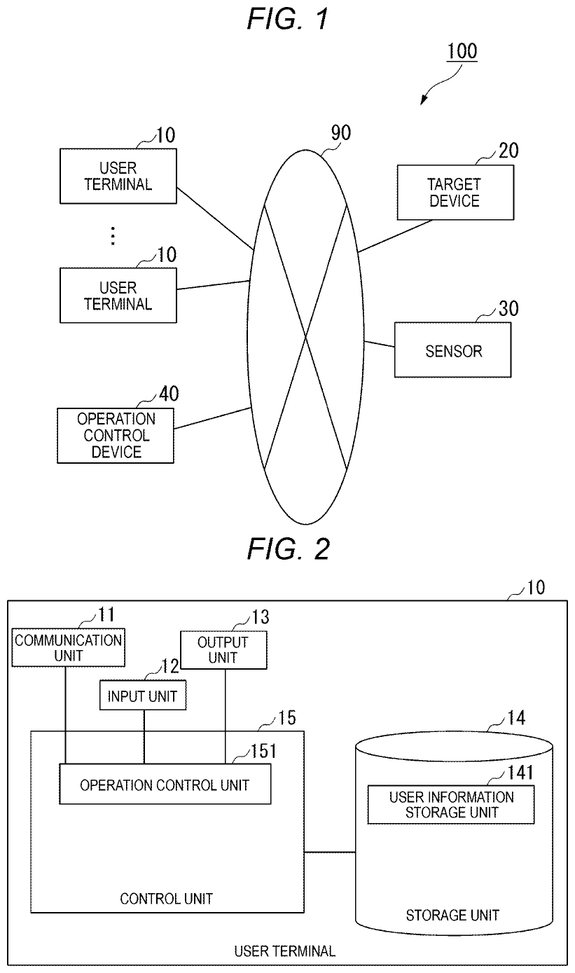

Hereinafter, an operation control device and an operation control method according to an embodiment will be described with reference to the drawings. FIG. 1 is a diagram showing a configuration example of a control system 100. The control system 100 includes a plurality of user terminals 10, a target device 20, a sensor 30, and an operation control device 40. The user terminals 10, the target device 20, and the sensor 30 are communicably connected to the operation control device 40 via a network 90. In one control system 100, a plurality of the target devices 20 and the sensors 30 may be used. In one control system 100, a plurality of the operation control devices 40 may be used.

The network 90 may be a network using wireless communication or a network using wired communication. The network 90 may be, for example, a local area network (LAN), may be configured as an internal network using a plurality of the LANs, may be configured using a wide area network (WAN), or may be configured using the Internet. The network 90 may be configured by combining a plurality of the networks.

FIG. 2 is a diagram showing a specific example of a functional configuration of the user terminal 10 (e.g., a user device). The user terminal 10 is configured using communicable information equipment. The user terminal 10 may be configured using a device such as a smartphone, a tablet, a personal computer, a television receiver, an image forming device (MFP: Multifunction Peripheral), a game device (e.g., a gaming console or handheld), or a wearable device (for example, a smart watch). The user terminal 10 includes a communication unit 11, an input unit 12, an output unit 13, a storage unit 14, and a control unit 15 (e.g., a controller).

The communication unit 11 (e.g., network interface) is configured using a communication interface. The communication unit 11 connects to the network 90 by wireless communication or wired communication, and performs data communication with other devices (for example, the operation control device 40).

The input unit 12 (e.g., an input device or input portion of a user interface) is configured using existing input devices such as a keyboard, a pointing device (e.g., mouse, tablet, or the like), buttons, or a touch panel. The input unit 12 is operated by a user when inputting a user's instruction into the user terminal 10. The input unit 12 may be an interface for connecting the input device to the user terminal 10. In this case, the input unit 12 causes the input device to input an input signal generated in response to a user's input, to the user terminal 10. The input unit 12 may be configured using a microphone and a voice recognition device. In this case, the control unit 15 performs voice recognition on the words uttered by the user, and acquires character string information as a result of the recognition. The input unit 12 may be configured in any manner that allows the user's instruction to be input to the user terminal 10.

The output unit 13 (e.g., an output device or output portion of a user interface) is a device that outputs information to the user. The output unit 13 may be configured using an image display device such as a liquid crystal display or an organic electroluminescence (EL) display. The output unit 13 may be an interface for connecting the image display device to the user terminal 10. In this case, the output unit 13 generates a video signal for displaying image data, and outputs the video signal to the image display device connected to the user terminal 10. The output unit 13 may be configured using a sound output device such as a speaker. The output unit 13 may be an interface for connecting the sound output device such as a speaker, earphones, or headphones to the user terminal 10.

The storage unit 14 (e.g., a memory) is configured using a storage device such as a magnetic hard disk device or a semiconductor memory device. The storage unit 14 stores data used by the control unit 15. The data stored in the storage unit 14 is read out by the control unit 15. The storage unit 14 functions as a user information storage unit 141, for example. The user information storage unit 141 stores information regarding the user who operates the user terminal 10 (hereinafter referred to as “user information”). The user information may include any information related to the user. For example, the user information may include attribute information of the user. Examples of the attribute information may include information regarding the user's body (for example, gender, age, height, weight, and medical history), information regarding the user's history (for example, place of birth), information regarding the user's current affiliation (for example, company the user works for, department, position, work location, office floor, and office room), information regarding the user's place of residence, or other information. The user information may include identification information assigned to the user (hereinafter referred to as “user identification information”), or identification information assigned to the user terminal 10 (own device) owned by the user (hereinafter referred to as “terminal identification information”).

The control unit 15 is configured using a memory and a processor such as a central processing unit (CPU). The control unit 15 functions as an operation control unit 151 by the processor executing a program. Note that all or part of functions of the control unit 15 may be implemented using hardware such as an application specific integrated circuit (ASIC), a programmable logic device (PLD), or a field programmable gate array (FPGA). The program may be recorded on a computer-readable recording medium. Examples of the computer-readable recording medium include portable media such as flexible disks, magneto-optical disks, ROMs, CD-ROMs, and semiconductor memory devices (for example, a solid state drive (SSD)), and storage devices such as hard disks and semiconductor memory devices built into computer systems. The program may be transmitted via a telecommunications line.

The control unit 15 may execute, for example, an application installed in advance on own device (i.e., the user terminal 10). A specific example of such an application includes an application provided to the user terminal 10 as a dedicated application for the control system 100. Other specific examples of such applications include web browser applications and applications executed on web browsers. The control unit 15 may operate according to the program of the application being executed.

The operation control unit 151 transmits information indicating operation contents (e.g., commands) for the target device 20 to the operation control device 40, based on the user's instruction given to the input unit 12. In this case, the operation control unit 151 may transmit part or all of the information included in the user information to the operation control device 40. For example, information such as the user identification information and the terminal identification information may be transmitted, part or all of the attribute information may be transmitted, or other information may be transmitted.

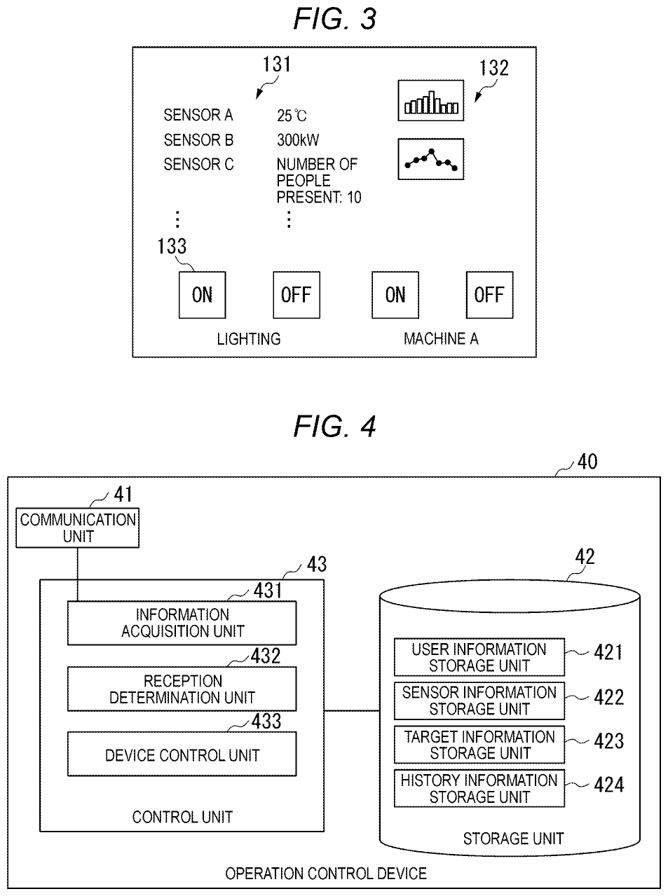

For example, the operation control unit 151 may cause the output unit 13 to display a screen serving as a user interface for operating the target device 20. The operation control unit 151 may cause the output unit 13 to output, for example, a sound for receiving an operation of the target device 20. FIG. 3 is a diagram showing a specific example of the screen serving as the user interface provided by the operation control unit 151. For example, information related to the target device 20 (hereinafter referred to as “control-related information”) may be displayed. In the example of FIG. 3, first control-related information 131 and second control-related information 132 are displayed.

The first control-related information 131 is control-related information expressed as a character string. The second control-related information 132 is control-related information expressed as an image (for example, a graph or a pictogram). In the example of FIG. 3, as the first control-related information 131, the measurement result of a sensor A (temperature 25 degrees), the measurement result of a sensor B (power consumption 300 kW), and the measurement result of a sensor C (the number of people present is 10) are shown. As the second control-related information 132, for example, a graph showing a time-series change in temperature and a graph showing a time-series change in power consumption may be shown.

Operation buttons 133 may be displayed on the screen serving as the user interface. In FIG. 3, as a specific example of the operation buttons 133, a button for turning on the power and a button for turning off the power are displayed for each of lighting and an air conditioner which are specific examples of the target device 20. In addition to these, the operation buttons 133 may be displayed depending on the characteristics of each target device 20. For example, the operation button 133 for changing the color of the lighting may be displayed, or the operation button 133 for changing the intensity of light of the lighting may be displayed. For example, the operation button 133 for changing the operation of the air conditioner (automatic, cooling, dry, heating, or the like) may be displayed, or the operation button 133 for changing the set temperature or the operation strength of the air conditioner may be displayed.

The target device 20 is a device to be controlled in the control system 100. The target device 20 may be, for example, equipment installed in a facility such as a home, an office, or a workplace. Specific examples of such equipment include air conditioning equipment, cooling equipment, heating equipment, humidifiers, dehumidifiers, lighting equipment, light shielding equipment (curtains, blinds, or the like), water heaters, and audio equipment (speakers, or the like).

The target device 20 includes a communication device. The target device 20 communicates with the operation control device 40 via the network 90 using the communication device. The target device 20 transmits information indicating a status of the target device 20 (hereinafter referred to as “status information”) to the operation control device 40 at predetermined timings (for example, every second, every 10 seconds, every minute, the timing when the status changes, or the like). The status information may be transmitted by acquiring, for example, information indicating a control status of the target device 20 from the memory of the target device 20, or may be transmitted by acquiring the information indicating the control status of the target device 20 from the sensor provided in the target device 20. The status information may include identification information indicating the target device 20 (hereinafter referred to as “target identification information”).

Upon receiving information indicating control (hereinafter referred to as “control information”) from the operation control device 40, the target device 20 controls the target device 20 according to the received control information. For example, if the control information is information indicating whether the power is turned on or off, the target device 20 turns the power on or off in accordance with the control information. For example, if the control information is information indicating that setting information is to be changed, the target device 20 changes setting information of the target device 20 in accordance with the control information.

The sensor 30 acquires information in a predetermined area. In the following description, the information acquired by the sensor 30 (e.g., sensor data) will be referred to as “acquisition information”. The acquisition information may include identification information (hereinafter referred to as “sensor identification information”) indicating the sensor 30 acquiring the information. The sensor 30 may be, for example, a sensor that measures temperature or a sensor that measures humidity. The sensor 30 may be a sensor that acquires the number of people present in a predetermined area (for example, a predetermined workplace). The sensor 30 may be configured using, for example, a human detection sensor provided near an entrance to a predetermined area. The direction of movement of people is detected by installing a plurality of the human detection sensors, and the number of people located within a predetermined area may be estimated by calculating the difference between the number of people moving in the direction of entering the predetermined area and the number of people moving in the direction of leaving the predetermined area. The sensor 30 may be a sensor that acquires information (for example, the user identification information) indicating a user who is present in a predetermined area (for example, a predetermined workplace). For example, the sensor 30 may acquire information indicating a user who is located within a predetermined area by communicating with a device (for example, a wireless tag) owned by a user located within the predetermined area or a device (for example, a wireless tag) provided in the user terminal 10. The sensor 30 transmits the acquisition information to the operation control device 40.

The operation control device 40 (e.g., an operation controller, a centralized controller, etc.) is configured using an information processing device such as a personal computer or a server. FIG. 4 is a schematic block diagram showing an example of a functional configuration of the operation control device 40. The operation control device 40 includes a communication unit 41, a storage unit 42, and a control unit 43.

The communication unit 41 (e.g., a network interface) is configured using a communication interface. The communication unit 41 performs data communication with other devices (for example, the user terminal 10, the target device 20, or the sensor 30) via the network 90.

The storage unit 42 is configured using a storage device such as a magnetic hard disk device or a semiconductor memory device. The storage unit 42 functions as a user information storage unit 421, a sensor information storage unit 422, a target information storage unit 423, and a history information storage unit 424.

The user information storage unit 421 (e.g., a memory) stores user information of the user terminal 10. The sensor information storage unit 422 stores information received from the sensor 30. The sensor information storage unit 422 may store, for example, the information received from the sensor 30 in association with date and time information such as the date and time of reception and the date and time of acquisition of the information.

The target information storage unit 423 (e.g., a memory) stores information regarding the target device 20 (hereinafter referred to as “target information”). The target information may include any information related to the target device 20. The target information may include, for example, for each target device 20, identification information indicating the target device 20 (target identification information), conditions used to determine whether or not to receive operations on the target device 20 (e.g., accept or ignore a requested command) from the user (hereinafter referred to as “reception condition”), and conditions used to determine the control content (e.g., the executed commands) of the target device 20 (hereinafter referred to as “determination condition”).

Specific examples of the reception condition include, for example, the installation location of the target device 20 and the conditions for a user who can operate the target device 20 (for example, the user's location, the user's affiliation, the user's position, or whether the user has an administrator authority). The reception condition may be, for example, a condition indicating a priority order regarding the user's affiliation or position. The reception condition may be that the user has the administrator authority. The reception condition may be, for example, a condition indicating the user's location. More specifically, the reception condition may be a condition indicating that the operation can be performed by a user who is located inside (within an area) a facility (for example, a floor, or an office) where the target device 20 to be operated is installed. The reception condition may be a condition indicating that the location of the target device 20 to be operated and the user's location are within a predetermined range. The reception condition may indicate that operations from other users are not to be received if the user who currently has the administrator authority is operating (for example, within a predetermined time after transmitting an operation screen).

The reception condition may be a condition related to a value, such as that a value of an instruction content exceeds a threshold value or the value of the instruction content does not exceed a threshold value. The threshold value used for the reception condition may be, for example, a predetermined value, or a value (for example, trend analysis results) obtained based on the values indicated by the control content or the instruction content used in a predetermined period of time from the past to the present. The reception condition may be a condition indicating that if the status of the target device 20 to be operated does not satisfy a predetermined condition indicating an abnormality, the operation of only the user with the administrator authority is received, and if the status of the target device 20 to be operated satisfies the predetermined condition indicating the abnormality, the operation of the user who does not have the administrator authority is also received.

Specific examples of the determination condition include, for example, a condition for making a determination based on statistical values (for example, an average value, a mode, a maximum value, or a minimum value) of set values for operations received within a predetermined time, or a determination condition when receiving different control contents (for example, if turning on and turning off are instructed within a predetermined time). For example, the determined value may be determined by using a weighted average of the set values for the operations received within a predetermined time. For example, the weighted average may be taken such that the older the item is, the smaller the weight is given, and the newer the item is, the larger the weight is given. The condition may be determined such that if the different control contents are received, the control content is determined based on the operation of a user with a higher priority order, in accordance with a predetermined priority order regarding the users (for example, the priority order according to the user's location, the priority order according to the user's affiliation, the priority order according to the user's position, or the user's own priority order).

The determination condition may be, for example, information indicating that the determination condition is obtained (for example, trend analysis) based on the values indicated by the control content or the instruction content used in a predetermined period of time from the past to the present. The determination condition may be, for example, information indicating that the determination condition is obtained (for example, trend analysis) based on values indicated by the instruction content from a specific user (for example, a user who is a transmission source of the operation information, a plurality of users correlated with the target device 20 to be controlled, or a plurality of users correlated with an area where the target device 20 to be controlled is installed) used in a predetermined period of time from the past to the present. For example, the determination condition may indicate that new control information is not transmitted to the same target device 20 until a predetermined time elapses after the control information is once transmitted.

The history information storage unit 424 stores information indicating the content of the operation performed on the target device 20 in the past (hereinafter referred to as “operation history information”) and information indicating the content of the control determined in the past for the target device 20 (hereinafter referred to as “determination history information”).

The control unit 43 is configured using a memory and a processor such as a CPU. The control unit 43 functions as an information acquisition unit 431, a reception determination unit 432, and a device control unit 433, by the processor executing a program. Note that all or part of functions of the control unit 43 may be implemented using hardware such as an ASIC, a PLD, or an FPGA. The program may be recorded on a computer-readable recording medium. Examples of the computer-readable recording medium include portable media such as flexible disks, magneto-optical disks, ROMs, CD-ROMs, and semiconductor memory devices (for example, an SSD), and storage devices such as hard disks and semiconductor memory devices built into computer systems. The program may be transmitted via a telecommunications line.

Upon receiving information from each sensor 30, the information acquisition unit 431 records the received information in the sensor information storage unit 422. Upon receiving the status information from each target device 20, the information acquisition unit 431 records the received status information in the target information storage unit 423.

Upon receiving the operation information from the user terminal 10, the reception determination unit 432 determines whether or not to receive the content of the operation indicated by the received operation information. In this case, the reception determination unit 432 makes a determination based on, for example, the reception condition of the target device 20 to be operated.

Upon receiving the operation information from the user terminal 10, the device control unit 433 determines the control content for the target device 20 to be operated, based on the received operation information. In this case, the device control unit 433 determines the control content, for example, based on the determination condition of the target device 20 to be operated.

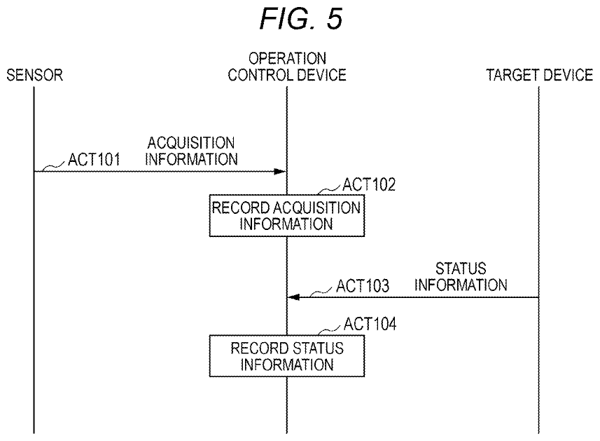

FIG. 5 is a sequence chart showing one specific example of an operation of the control system 100. The sensor 30 acquires information indicating the sensing result at a predetermined timing. The sensor 30 transmits the acquired information (acquisition information) to the operation control device 40 (ACT 101). Upon receiving the acquisition information, the information acquisition unit 431 of the operation control device 40 records the received acquisition information in the sensor information storage unit 422. The target device 20 acquires the status information indicating the status of the target device 20 at a predetermined timing. The target device 20 transmits the acquired status information to the operation control device 40 (ACT 103). Upon receiving the status information, the information acquisition unit 431 of the operation control device 40 records the received status information in the target information storage unit 423. The processes in ACT 101 and ACT 102 and the processes in ACT 103 and ACT 104 shown in FIG. 5 may be performed in different orders, and the frequency may not be one-to-one. For example, the processes in ACT 103 and ACT 104 may be executed once while the processes in ACT 101 and ACT 102 are executed multiple times. For example, while the processes in ACT 101 and ACT 102 are executed periodically, the processes in ACT 103 and ACT 104 may be executed irregularly (for example, only when the status is changed).

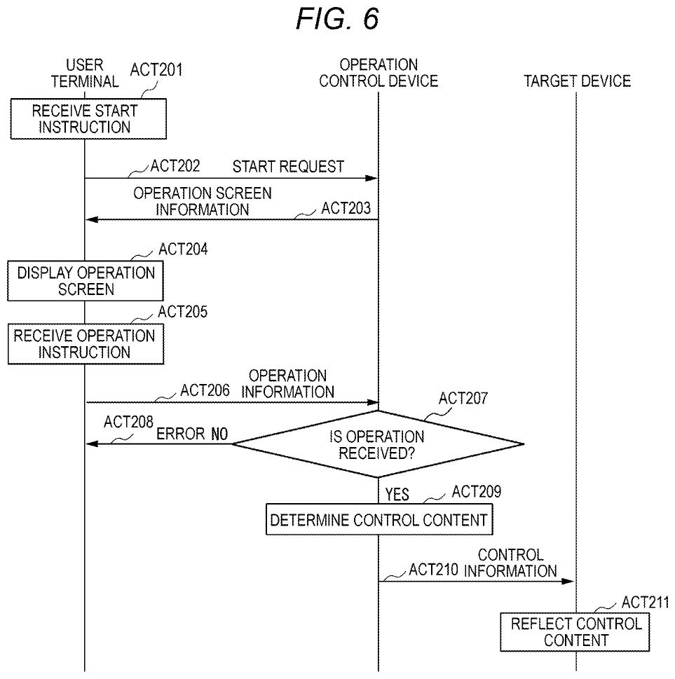

FIG. 6 is a sequence chart showing one specific example of the operation of the control system 100. Upon receiving an instruction (start instruction) indicating that the user starts operating the target device 20 (ACT 201), the control unit 15 of the user terminal 10 transmits a start request to the operation control device 40 (ACT 202). The start instruction may be, for example, an instruction to start an application for operating the target device 20 or an instruction to access a website for operating the target device 20 using a browser, and may also be performed in other ways.

Upon receiving the start request from the user terminal 10, the reception determination unit 432 of the operation control device 40 transmits operation screen information to the user terminal 10 (ACT 203). The reception determination unit 432 may generate the operation screen information such that the target device 20 that cannot be operated or the button that cannot be operated in the operation screen information (for example, a button indicating the target device 20 or the operation contents of which the user does not satisfy the reception condition) is displayed in a display mode (for example, grayed out) different from the display modes of other images or buttons. The reception determination unit 432 may generate the operation screen information that includes only the button indicating the target device 20 and the operation contents of which the user satisfies the reception condition. Upon receiving the operation screen information, the operation control unit 151 of the user terminal 10 displays an operation screen based on the received operation screen information (ACT 204).

If the user operates the operation screen to input instructions for the target device 20, the user terminal 10 receives the input instructions (ACT 205). The operation control unit 151 of the user terminal 10 generates the operation information based on the input instructions. The operation information includes, for example, the target identification information indicating the target device 20 to be operated, information indicating the operation contents, and information indicating the operating user (the user identification information or the terminal identification information). The operation control unit 151 of the user terminal 10 transmits the generated operation information to the operation control device 40 (ACT 206).

Upon receiving the operation information, the reception determination unit 432 of the operation control device 40 determines whether or not to receive the operation indicated by the operation information, based on the received operation information (ACT 207). For example, if it is determined that the reception condition is not satisfied (NO in ACT 207), the reception determination unit 432 transmits an error to the user terminal 10 that is the transmission source of the operation information (ACT 208).

If it is determined that the reception condition is satisfied (YES in ACT 207), the reception determination unit 432 notifies the device control unit 433 of the determination result. The device control unit 433 determines the control content for the target device 20, based on the received operation information (ACT 209). For example, the device control unit 433 determines the control content, based on the received operation information and the determination condition of the target device 20 to be operated. The device control unit 433 generates the control information that is information for controlling the target device 20 with the determined control content. Then, the device control unit 433 transmits the control information to the target device 20 to be operated (ACT 210). Upon receiving the control information, the target device 20 reflects the control content indicated by the received control information in the status and settings of the target device 20 (ACT 211).

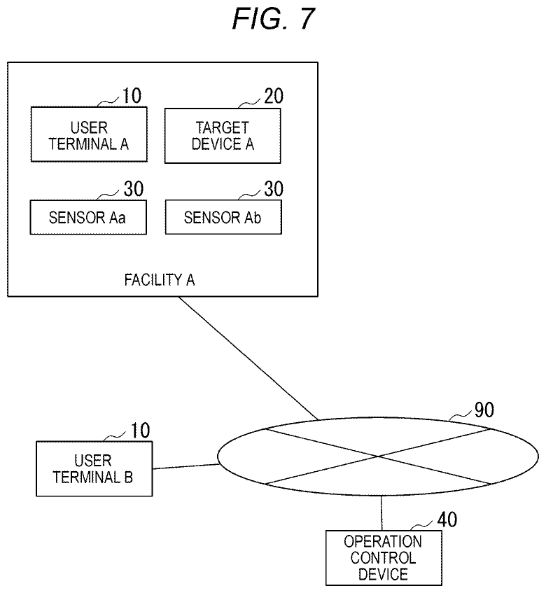

FIG. 7 is a diagram showing a specific example of the control system 100. In the example of FIG. 7, the control system 100 is applied to a facility A (e.g., a predefined area defining a boundary of the facility A). In the facility A, a target device A is installed, and a sensor Aa and a sensor Ab are installed. A user A who has a user terminal A is located in the facility A. A user B who has a user terminal B is located outside the facility A.

If the user A and the user B transmit operation information regarding the target device A at close timings (within a predetermined time period), the reception determination unit 432 of the operation control device 40 may determine to receive (e.g., accept) the operation information transmitted from the user terminal A and not to receive (e.g., ignore) the operation information transmitted from the user terminal B. For example, such a determination may be made based on the fact that the location of the user terminal B (user B) is not within the facility A. On the other hand, such a determination may be made based on the fact that the location of the user terminal A (user A) is within the facility A.

If the user A and the user B transmit the operation information regarding the target device A at close timings (within a predetermined time period), the device control unit 433 of the operation control device 40 may determine the control content, based on the operation information transmitted from the user terminal A and the operation information transmitted from the user terminal B. For example, the control content may be determined by treating the control content of the user A and the user B equally, or the control content may be determined by giving priority to the control content of the user A, based on the fact that the user A is located within the facility A and the user B is not located within the facility A.

With the control system 100 configured in this way, it becomes possible to more appropriately control the target device 20 used by a plurality of users. Specifically, the details are as follows.

In the control system 100, if the operation information is received from the plurality of users, only the operation information of the user who satisfies the reception condition is received. Therefore, even if the target device 20 is used by the plurality of users, the operation information of the user who does not satisfy the reception condition (for example, the user who does not have the administrator authority) is not applied. Therefore, it is possible to avoid a situation where control is performed by an unspecified number of users, and to implement more appropriate control.

In the control system 100, if the operation information is received from the plurality of users at close timings (within a predetermined time period), the control content is determined according to the determination condition based on the plurality of pieces (components) of operation information. More specifically, the control content is determined using the statistical values such as the weighted average. Therefore, even if different pieces of operation information are transmitted by the plurality of users, it is possible to prevent settings from being drastically changed each time, and to implement more appropriate control.

### Modification Example

In the sequence chart of FIG. 6, the processes in ACT 202 and ACT 203 may not be executed. In this case, for example, the operation screen may be displayed in ACT 204, based on information regarding the operation screen that is recorded in advance in the storage device of the user terminal 10 in response to the start instruction in ACT 201.

The operation control device 40 does not necessarily need to be configured as a single device. For example, the operation control device 40 may be configured using a plurality of information processing devices (e.g., a distributed computing system). The plurality of information processing devices that configure the operation control device 40 may be communicably connected via a communication path such as the network 90, and may be configured as a system such as a cluster machine or a cloud.

Although the embodiment of the disclosure has been described in detail with reference to the drawings, specific configurations are not limited to the above-described embodiments, and designs and the like within the scope not deviating from the gist of the disclosure are included.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An operation control device comprising a controller configured to:
receive a component of operation information from each of a plurality of user terminals, each component of operation information indicating a requested command for a target device;
generate a command for the target device based on the components of operation information; and
control the target device in accordance with the generated command.

2. The operation control device of claim 1, wherein the controller is configured to:
determine a priority order for the components of operation information based on information regarding a user who is a transmission source of each of the components of operation information; and
generate the command based on the priority order.

3. The operation control device of claim 1, wherein the controller is configured to generate the command based on (a) the components of operation information and (b) information regarding a location of a user who is a transmission source of each of the components of operation information.

4. The operation control device of claim 3, wherein the controller is configured to generate the command based on information regarding a location where the target device is installed.

5. The operation control device of claim 1, wherein in response to receiving new operation information, the controller is configured to generate the command based on the new operation information and operation information received within a predetermined period of time before the new operation information is received.

6. The operation control device of claim 5, wherein the controller is configured to generate the command based on the new operation information in response to a determination that a user who is a transmission source of the new operation information is located within of a predefined area.

7. The operation control device of claim 6, wherein the predefined area contains the target device.

8. The operation control device of claim 1, wherein the controller is configured to ignore a new requested command for the target device in response to a determination that a user who is a transmission source of the new requested command is located outside of a predefined area.

9. The operation control device of claim 8, wherein the predefined area contains the target device.

10. The operation control device of claim 1, wherein the controller is configured to:
determine a priority order for the components of operation information based on a timing when each component of operation information is received; and
generate the command based on the priority order.

11. The operation control device of claim 10, wherein the controller is configured to assign a first component of operation information a lower priority than a second component of operation information in response to a determination that the first component of operation information was received before the second component of operation information.

12. The operation control device of claim 11, wherein the controller is to generate the command based on a weighted average of set values identified in the requested commands, wherein the controller is configured to assign a first weight to a first set value corresponding to the first component of operation information, wherein the controller is configured to assign a second weight to a second set value corresponding to the second component of operation information, and wherein the first weight is smaller than the second weight.

13. The operation control device of claim 1, wherein the controller is configured to generate the command based on (a) the components of operation information and (b) information regarding an authority level of a user who is a transmission source of each of the components of operation information.

14. The operation control device of claim 1, wherein the controller is configured to ignore a new requested command for the target device in response to a determination that a user who is a transmission source of the new requested command lacks administrator authority.

15. The operation control device of claim 1, wherein the target device includes at least one of air conditioning equipment, cooling equipment, heating equipment, a humidifier, a dehumidifier, lighting equipment, light shielding equipment, a water heater, or audio equipment.

16. An operation control method performed by an operation control device including a controller, the operation control method comprising:
receiving a component of operation information from each of a plurality of user terminals, each component of operation information indicating a requested command for a target device;
generating a command for the target device based on the components of operation information; and
controlling the target device in accordance with the generated command.

17. The operation control method of claim 16, further comprising determining a priority order for the components of operation information based on information regarding a user who is a transmission source of each of the pieces of operation information, wherein the command is generated based on the priority order.

18. The operation control method of claim 16, wherein the command is generated based on (a) the components of operation information and (b) information regarding a location of a user who is a transmission source of each of the components of operation information.

19. The operation control method of claim 16, wherein the command is generated based on information regarding a location where the target device is installed.

20. A system comprising:
a target device;
a first user device configured to receive a first requested command for the target device from a first user;
a second user device configured to receive a second requested command for the target device from a second user;
an operation control device operatively coupled to the target device, the first user device, and the second user device and comprising a controller configured to:
receive the first requested command and the second requested command;
generate a command for the target device based on the first requested command, the second requested command, information regarding the first user, and information regarding the second user; and
control the target device in accordance with the generated command.
